(19) United States
(12) Patent Application Publication
(10) Pub. No.: US 2015/0318771 A1
(43) Pub. Date: Nov. 5, 2015

(54) STEP MOTOR AND METHOD OF MANUFACTURING THEREOF

(71) Applicant: SEONG-KWAN OH, Incheon (KR)

(72) Inventor: SEONG-KWAN OH, Incheon (KR)

(21) Appl. No.: 14/267,700

(22) Filed: May 1, 2014

(51) Int. Cl. H02K 15/14; H02K 15/04

(52) U.S. Cl. CPC H02K 15/14; H02K 15/04

(57) ABSTRACT

Disclosed are a step motor and a manufacturing method thereof. The step motor includes a stator having a bobbin in which a coil is received to generate a magnetic field when power is supplied, and a yoke having a plurality of yoke teeth engaged with the bobbin, a casing covering and protecting the stator, and a rotor inserted into an inner diameter part of the stator and having magnets on a circumference of a rotary shaft, so as to generate rotary force, wherein a bearing is installed to an end of the rotary shaft to support the rotor, and an elastic member is assembled to the bearing to force the end of the rotary shaft inwards in a motor assembly composed of the stator and rotor.

### RELATED APPLICATION

This application is a divisional application of U.S. patent application Ser. No. 13/369,237 for “STEP MOTOR AND METHOD OF MANUFACTURING THEREOF” filed on Feb. 8, 2012.

### BACKGROUND OF THE INVENTION

1. Field of the Invention

The present invention relates, in general, to a permanent magnet (PM) type step motor having a lead screw which is used to carry a mobile camera lens and an optical pickup lens of a media-related device and, more particularly, to a PM type step motor in which a bearing is installed to an end of a rotary shaft of a rotor so that an elastic member can be fixed to the bearing so as to force the end of the rotary shaft inwards, allowing related parts of the end structure of the rotary shaft to be assembled together by means of mechanismic coupling, thereby enabling the assembly of the end structure of the rotary shaft to be strong without performing welding or the like, and improving the precision as well as mechanismic assembly, thereby reducing manufacturing costs by reducing the labor and period of manufacture, and a manufacturing method thereof.

2. Description of the Related Art

Generally, a permanent magnet (PM) type step motor, in which a lead screw is installed, to carry a mobile camera lens and an optical pickup lens of a media-related device, includes: a stator having a bobbin in which a coil is received to generate magnetic field when it is power-activated, and a yoke having a plurality of yoke teeth engaged with the bobbin; a casing covering and protecting the stator; a rotor which is inserted into an inner diameter part of the stator, a circumference of the rotary shaft having magnets located thereon, so as to generate rotary force; a lead screw which is fixedly coupled to one end of the rotary shaft so as to convert the rotary force of the rotary shaft to linear motion and transmit the same to the outside; and a bracket which mounts a motor assembly consisting of the stator and rotor therein.

In such a step motor, in the assembly of the end structure of the rotary shaft that protrudes out of the casing, the bearing is installed such that the outside is covered by a motor cover, or otherwise an elastic member such as a leaf spring is welded to the outside of the casing in order to force the end of the rotary shaft inwards.

However, welding the elastic member to the casing in order to force the end of the rotary shaft inwards generates the problems of increasing the labor required and the period for manufacture and of reducing the precision.

### SUMMARY OF THE INVENTION

Accordingly, the present invention has been made keeping in mind the above problems occurring in the related art, and a purpose of the present invention is to propose a step motor in which a bearing is installed to an end of a rotary shaft of a rotor so that an elastic member is fixed to the bearing so as to force the end of the rotary shaft inwards, allowing related parts of the end structure of the rotary shaft to be assembled together by means of a mechanismic coupling, thereby enabling the assembly of the end structure of the rotary shaft to be strong without performing welding or the like, and improving precision as well as mechanismic assembly, thereby reducing manufacturing costs owing to a reduction in labor and period of manufacture, and a manufacturing method thereof.

In order to achieve the above object, according to one aspect of the present invention, there is provided a step motor including: a stator having a bobbin in which a coil is received to generate magnetic field when it is power-activated, and a yoke having a plurality of yoke teeth engaged with the bobbin; a casing covering and protecting the stator; and a rotor inserted into an inner diameter part of the stator, a circumference of a rotary shaft having a magnet located thereon, so as to generate a rotary force, wherein a bearing is installed to an end of the rotary shaft to support the rotor, and an elastic member is assembled to the bearing to force the end of the rotary shaft inwards in such a motor assembly composed of the stator and rotor.

The step motor further includes: a lead screw fixedly coupled to one end of the rotary shaft so as to convert the rotary force of the rotary shaft to linear motion and transmit the same to the outside; and a bracket fixedly mounting the motor assembly.

The bearing partially protrudes out of the casing, and the elastic member may be assembled to the protruding portion of the bearing such that the elastic member and the bearing are assembled together with the casing interposed therebetween.

The bearing is provided with a central hole through which the end of the rotary shaft passes, and has a 2-step structure having a large-diameter part and a small-diameter part, the diameter of the small-diameter part being less than that of the large-diameter part, the small-diameter part protruding out of the casing when it is coupled with the casing.

A coupling groove to which the elastic member is assembled is provided on a circumference of the small-diameter part.

The elastic member is composed of a planar part designed to come into contact with the casing or a plate mounted onto the outer surface of the casing, and an elastic part bent at an angle from an end of the planar part in such a manner as to be opposite the planar part and separated therefrom by a certain distance, thereby forcing the end of the rotary shaft inwards in the motor assembly.

The planar part is provided with a cutout having a circular cutout part coming into contact with an outer circumferential surface of the bearing, which protrudes to the outside when it is coupled to the casing, while being partially opened at a portion, and opposite linear cutout parts extending downwards from the opened portion of the circular cutout part.

The linear cutout parts extend downwards at an angle such that the distance between the linear cutout parts gradually increases.

The planar part is further provided on opposite ends with reinforcing parts that are bent and are a certain length long.

The elastic member is directly or indirectly mounted to the casing with or without a plate interposed therebetween.

The casing has an internal cavity defined by the bottom having a through-hole and a sidewall erected from the bottom along a circumference of the bottom.

The through-hole is further provided with a plurality of yoke teeth protruding from the circumference thereof, and a plate is welded to the outside of the bottom.

The plate welded to the outside of the bottom is provided with a hole.

In accordance with another aspect of the present invention, there is provided a method of manufacturing a step motor, the method including: assembling a bobbin wound with a coil and a yoke into a casing, forming a stator assembly, and independently from assembly with the stator assembly, mounting a magnet around a rotary shaft to which a lead screw is fixedly coupled, thereby forming a rotor assembly; fixedly mounting one surface of a bracket to one surface of the stator assembly; mounting a bearing to another surface of the bracket; assembling the rotor assembly both to the stator assembly and to the bracket; mounting the bearing to an end of the rotary shaft; and assembling an elastic member to the bearing.

The method further includes: mounting a plate to the outside of the casing after mounting the bearing to the end of the rotary shaft.

According to the construction of the step motor of the present invention, a bearing is installed to an end of a rotary shaft of a rotor so that an elastic member is fixed to the bearing so as to force the end of the rotary shaft inwards, allowing related parts of the end structure of the rotary shaft to be assembled together by means of mechanismic coupling, thereby enabling the assembly of the end structure of the rotary shaft to be strong without performing welding or the like, and improving precision as well as mechanismic assembly, thereby reducing manufacturing costs owing to a reduction in labor and period of manufacture, and a manufacturing method thereof.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is an exploded perspective view showing the overall construction of a step motor according to an embodiment of the present invention;

FIG. 2 is an assembled view showing the step motor;

FIG. 3 is an assembled cross-sectional view of the step motor;

FIG. 4 is an enlarged view showing a characteristic feature of the step motor;

FIGS. 5A and 5B are detailed views showing a bearing of the step motor;

FIGS. 6A and 6B are detailed views showing an elastic member of the step motor;

FIGS. 7A and 7B are views showing embodiments of a casing of the step motor; and

FIGS. 8A to 8H are views showing a procedure of a method of manufacturing the step motor.

### DETAILED DESCRIPTION OF THE INVENTION

Reference will now be made in greater detail to a preferred embodiment of the invention, an example of which is illustrated in the accompanying drawings. Wherever possible, the same reference numerals will be used throughout the drawings and the description to refer to the same or like parts.

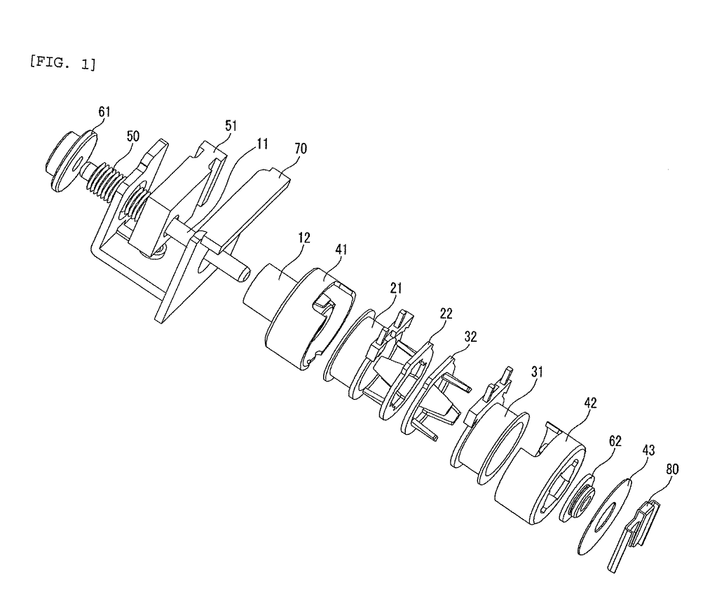

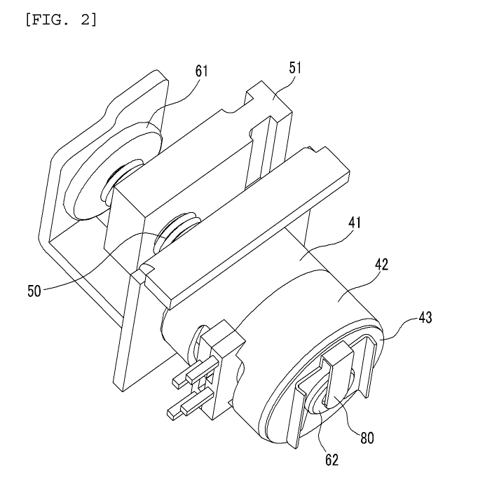

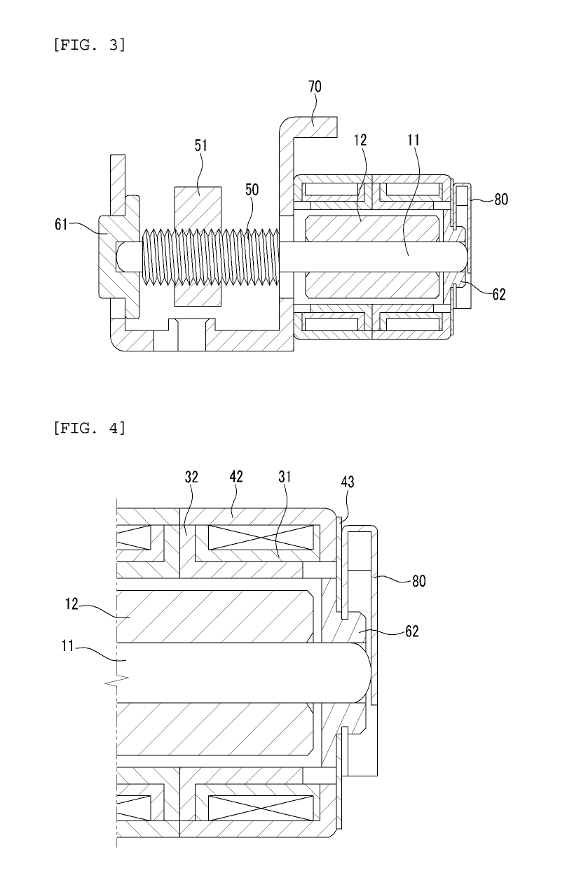

As shown in FIGS. 1 to 3, a step motor according to an embodiment includes a motor assembly, which includes a stator having a first stator section and a second stator section, casings 41 and 42 which cover and protect the first and second stator sections, respectively, and a rotor which is inserted into an inner diameter part of the stator so as to generate rotary force. The first stator section has a first bobbin 21 around which a coil is wound to generate a magnetic field when it is power-activated, and a first yoke 22 having a plurality of yoke teeth, which is inserted into the first bobbin 21. The second stator section has a second bobbin 31 around which a coil is wound to generate a magnetic field when it is power-activated, and a second yoke 32 having a plurality of yoke teeth, which is inserted into the second bobbin 31. The stator is formed by putting the first and second stator sections into contact with each other and coupling them. The rotor is composed of a rotary shaft 11 and a magnet 12 of a certain size, N- and S-poles of which alternate and are arranged on the outer surface of the rotary shaft 11.

Additionally, the step motor further includes a lead screw 50 which is fixedly coupled to one end of the rotary shaft 11 so as to convert the rotary force of the rotary shaft 11 to linear motion and transmit the same to the outside, a joint 51 which is linearly moved so as to transmit moving force to other applied mechanisms as the lead screw 50 moves, a bracket 70 which fixedly mounts a motor assembly consisting of the stator and rotor, and bearings 61 and 62 which are respectively mounted around ends of the lead screw 50 and rotary shaft 11 so as to smoothly support rotation of the rotary shaft 11.

As shown in the figures, the casing 42 is provided with a through-hole 42c through which the bearing 62 is mounted, and the end of the rotary shaft 11 is inserted through a hole 62d of the bearing 62 in such a manner as to protrude by a certain length.

An elastic member 80 is slidably inserted into and assembled to the end portion of the rotary shaft 11 protruding out of the bearing 62, so that the bearing 62 and the elastic member 80 are coupled together with the casing 42 interposed therebetween, so that the elastic member 80 forces the end portion of the rotary shaft inwards in the motor assembly.

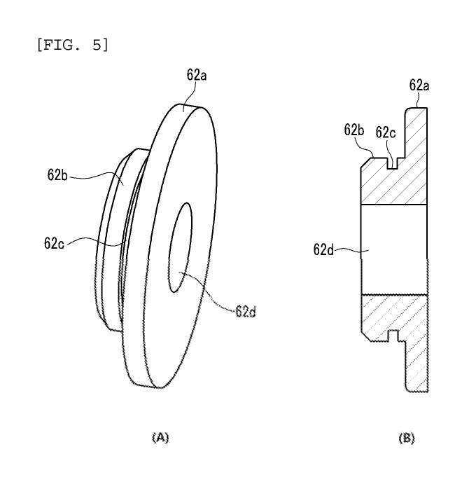

As shown in FIGS. 5A and 5B (FIG. 5A is a perspective view and FIG. 5B is a cross-sectional view), the bearing 62 is provided with a central hole 62d through which the end of the rotary shaft 11 passes, and has a 2-step structure having a large-diameter part 62a of a certain diameter and a small-diameter part 62b, the diameter of the small-diameter part being less than that of the large-diameter part 62a, the small-diameter part 62b protruding out of the casing 42 when it is coupled with the casing 42. A coupling groove 62c, to which the elastic member 80 is assembled, is provided on a circumference of the small-diameter part 62b.

As shown in FIGS. 6A and 6B (FIG. 6A is a perspective view, and FIG. 6B is a front view), the elastic member 80 is composed of a planar part 43 which is designed to come into contact with a plate 43 mounted onto the outer surface of the casing 42, a protrusion 82 which protrudes from the end of the planar part 81, and an elastic part 83 which is bent and forms an angle with the protrusion 82 in such a manner as to be opposite the planar part 81 and separated therefrom by a certain distance, thereby forcing the end of the rotary shaft 11 inwards in the motor assembly. Here, the plate 43 may be omitted such that the planar part 81 of the elastic member 80 comes into direct contact with the casing 42. That is, the elastic member 80 may be directly or indirectly mounted to the casing 42 with or without the plate 43 interposed therebetween.

Further, the elastic member 80 may be configured such that the protrusion 82 is omitted so that the elastic part 83 can be bent directly from the end of the planar part 81 in such a manner as to be opposite the planar part 81 and separated therefrom by a certain distance.

The planar part 81 is provided with a cutout 84, which has a circular cutout part 84b coming into contact with an outer circumferential surface of the bearing 62, which protrudes to the outside when it is coupled to the casing 42, while being partially opened at a portion, and opposite linear cutout parts 84a extending downwards from the opened portion of the circular cutout part 84b.

The size of a dimension of the circular cutout part 84b is preferably the same as the outer diameter of the coupling groove 62c such that the circular cutout part is slidably inserted into and assembled to the coupling groove 62c of the bearing 62. In addition, the linear cutout parts 84a preferably extend downwards at an angle such that a distance between the linear cutout parts gradually increases, so that the linear cutout parts 84a can be slidingly inserted into and assembled to the coupling groove 62c of the bearing 62.

Because of the inclination of the linear cutout parts 84a, when the elastic member 80 is inserted, the linear cutout parts 84a first expand away from each other and then the circular cutout part 84b elastically contracts and is fitted into the coupling groove 62c of the bearing 62, making it difficult for the circular cutout part 84b to become disconnected from the coupling groove 62c.

The planar part 81 is further provided on opposite ends with reinforcing parts 85 that are bent and have a certain length, the reinforcing parts serving as a grip portion used for assembling the elastic member 80 to the bearing 62, and also serving to reinforce the planar part 81 as well.

Further, in order to reduce the number of assembly processes, the backside of the planar part of the elastic member 80 (the portion that comes into contact with the casing 42) may be fixedly mounted to the casing 42.

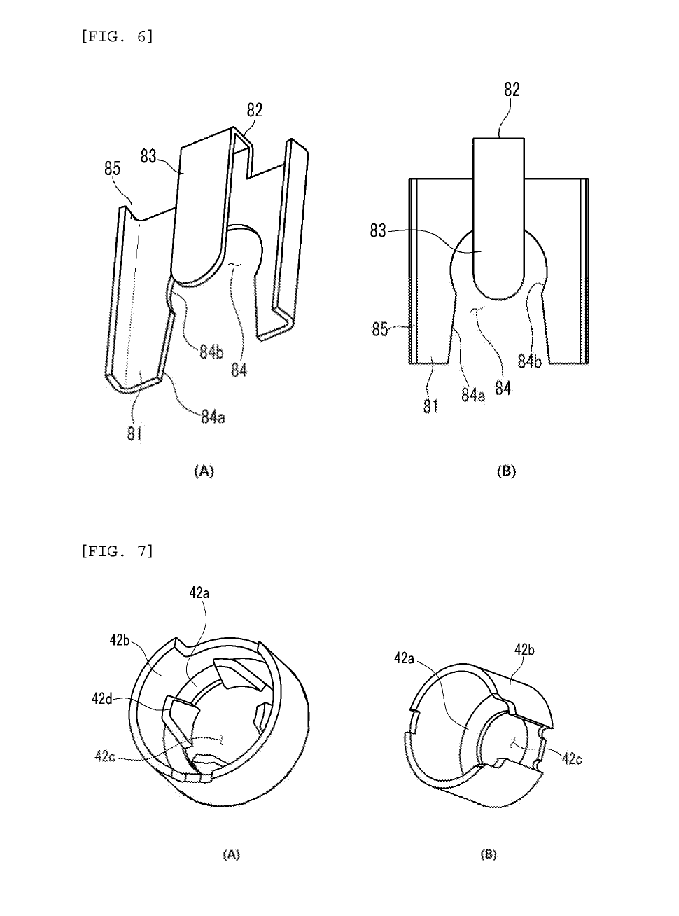

As shown in FIG. 7A, the casing 42 has an internal cavity which is defined by the bottom 42a having a through-hole 42c, through which the bearing 62 is inserted and installed, and a sidewall 42b which is erected from the bottom along a circumference of the bottom. The through-hole 42c is provided with a plurality of yoke teeth 42d erected from the circumference thereof. A shown in FIG. 7B, the yoke teeth 42d erected from the outer circumference of the through-hole 42c may not be formed to the casing 42, but may be separately formed.

The plate 43 may be fixedly welded to the outside of the bottom 42a of the casing 42, and the plate 43 may be provided with a hole (not designated) through which the bearing 62 passes.

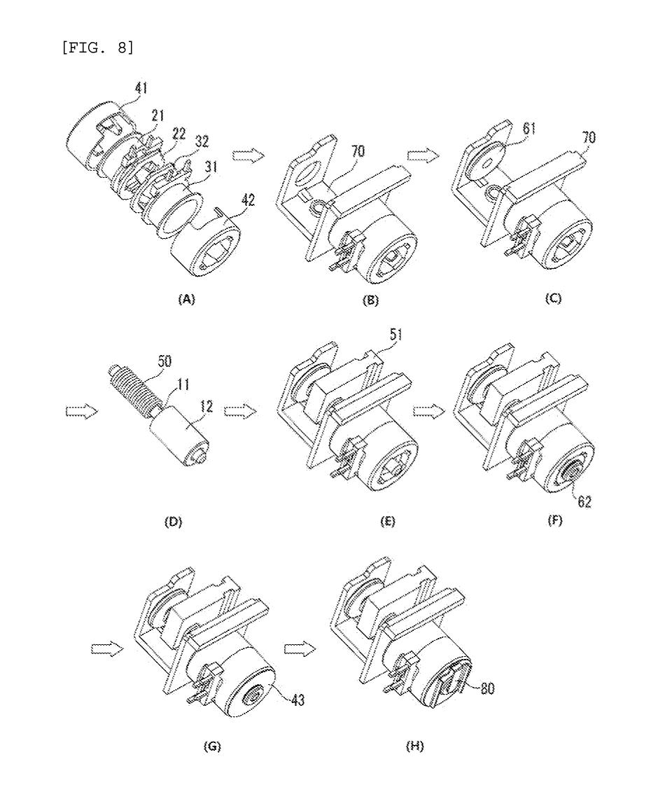

A method of manufacturing the step motor will now be described with reference to FIG. 8.

As shown in FIG. 8, the method includes assembling bobbins 21 and 31 wound with a coil and yokes 22 and 32 into casings 41 and 42, forming a stator assembly (FIG. 8A), and independently from assembly with the stator assembly, mounting a magnet 12 around a rotary shaft 11 to which a lead screw 50 is fixedly coupled, thereby forming a rotor assembly (FIG. 8D).

Next, the method includes fixedly mounting one surface of a bracket 70 to one surface of the stator assembly (FIG. 8B), and mounting a bearing 61 to another surface of the bracket 70 (FIG. 8C).

Next, the method includes inserting and assembling the rotor assembly (FIG. 8D) to the stator assembly (FIG. 8C) assembled with the bracket 70, forming an assembly (FIG. 8E). Here, a joint 51 may be mounted to the lead screw 50 of the rotor assembly.

Next, the method includes mounting the bearing 62 to an end of the rotary shaft 11 (FIG. 8F). The plate 43 may be further mounted to the outside of the casing 42 (FIG. 8G).

Next, the step motor of the present invention can be completed by sliding an elastic member along the bearing 62 and assembling the elastic member to the bearing 62 (FIG. 8H).

According to the manufacturing method, when assembling the end structure of the rotary shaft 11, the end structure can be firmly assembled with a mechanismic assembly relationship and without using welding or the like, thereby providing the effect of reduced manufacturing costs.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A method of manufacturing a step motor, the method comprising:
assembling a bobbin wound with a coil and a yoke into a casing, forming a stator assembly, and independently from assembly with the stator assembly, mounting a magnet around a rotary shaft to which a lead screw is fixedly coupled, thereby forming a rotor assembly;
fixedly mounting one surface of a bracket to one surface of the stator assembly;
mounting a bearing to another surface of the bracket;
assembling the rotor assembly both to the stator assembly and to the bracket; mounting the bearing to an end of the rotary shaft; and
assembling an elastic member to the bearing.

2. The method according to claim 1, further comprising:
mounting a plate to the outside of the casing after mounting the bearing to the end of the rotary shaft.
